(19) United States
(12) Patent Application Publication
(10) Pub. No.: US 2005/0018048 A1
(43) Pub. Date: Jan. 27, 2005

(54) Binocular having digital image storage function

(76) Inventors: Kuocheng Wu, Hsinchu (TW); Chung Lung Lin, Hsinchu (TW)

Correspondence Address: RABIN & CHAMPAGNE, P.C., Suite 500, 1101 14th Street, N.W., Washington, DC, 20005, US

(21) Appl. No.: 09/928,693

(22) Filed: Aug. 14, 2001

(51) Int. Cl. H04N 5/225

(52) U.S. Cl. 348/207.99

(57) ABSTRACT

A mid-range binocular is provided between two body tubes with a digital image storage unit of 100,000 or 350,000 pixels to provide digital image storage function. The binocular and the digital image storage unit have parallel optical axes, so that an image taken by the digital image storage unit is the same as a picture observed via the binocular, and a user may always take desired images with the digital image storage unit. The binocular having digital image storage function is a product integrating digital electronic technology and optical designing technique to provide acceptable image quality at popular price, and is suitable for use in observing and photographing images of, and recording sound or voice of things or persons at a distance about 50 to 200 meter away.

### FIELD OF THE INVENTION

The present invention relates to a novel binocular, and more particularly to a binocular having digital image storage function for conveniently using in a big-scale activity for taking images and recording voices of favorite persons at a mid-range distance.

### BACKGROUND OF THE INVENTION

A binocular has been developed for quite a long time and is very popular among consumers now. The binocular is often used in big-scale activities, such as ball games, musical performances, and speeches in public, for observing specific person or persons from a distant location. However, there are also people desiring to record such persons' characteristic expression or movement in addition to watch them distantly.

Digital camera has also been highly developed in recent years. It has become a widely welcomed photographing tool due to its convenience and reduced price. A disadvantage of the digital camera is it is limited to take photos of figures within a close distance due to a lens having a short focal length. When a digital camera is used to take picture of a specific person from a long distance in a big-scale activity, the obtained image is relatively small and unclear. In the case of a high-magnification zoom lens, it is expensive and increases dimensions of the camera, making the same inconvenient for handling.

### SUMMARY OF THE INVENTION

It is therefore a primary object of the present invention to integrate current digital electronic technology and optical designing skill to develop a binocular having digital image storage function that provides acceptable image quality at popular price, and is suitable for use in observing, photographing, and recording sounds or voices of things or persons at a distance about 50 to 200 meter away.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a binocular having digital image storage function according to an embodiment of the present invention;

FIG. 2 schematically shows the structure of the present invention;

FIG. 3 shows the rectangular fields of view of the binocular and the digital image storage unit of the present invention;

FIG. 4 is a block diagram of the circuitry of the digital image storage unit included in the present invention; and

FIG. 5 schematically shows a relative position of a mini liquid crystal display (LCD) included in the digital image storage unit of the present invention.

### DETAILED DESCRIPTION OF THE PREFERRED EMBODIMENTS

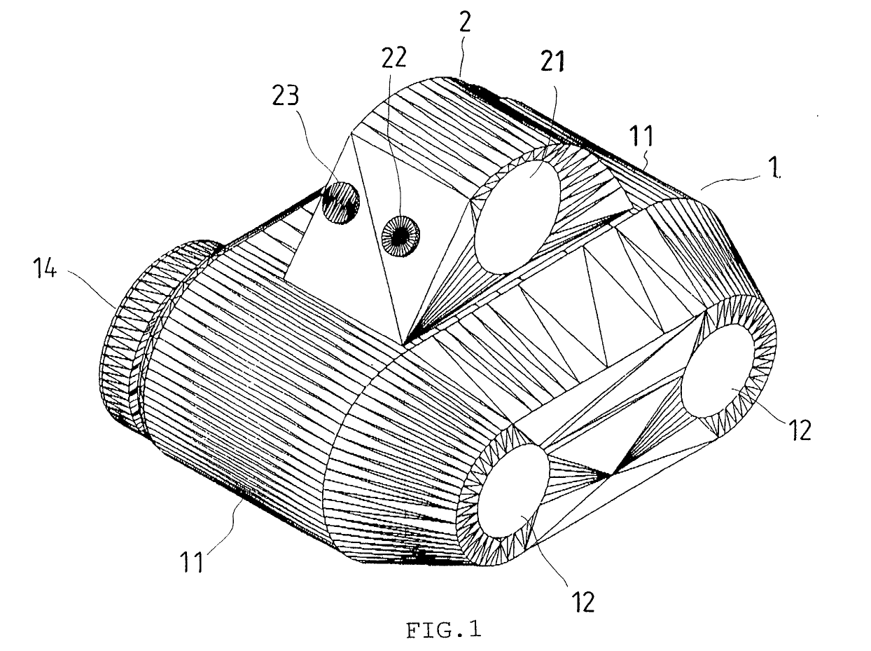

Please refer to FIG. 1 that is a perspective view of an embodiment of the present invention. As shown, the present invention includes a binocular 1 and a digital image storage unit 2 of 100,000 or 350,000 pixels.

The binocular 1 includes two body tubes 11, each of which is provided at two ends with an objective lens 12 and an eyepiece 14, and at a predetermined position between the objective lens 12 and the eyepiece 14 with a prism 13, preferably a Porro prism, enabling the binocular 1 to function like a mid-range telescope.

The digital image storage unit 2 is located between the two body tubes 11. The digital image storage unit 2 is provided at an end adjacent to the objective lens 12 of the binocular 1 with a charge-coupled device (CCD) lens 21, and at one lateral side with a shutter key 22 for taking a picture and a mode-switching key 23 for switching among different functions of the digital image storage unit 2.

Unlike a conventional binocular that has a circular field of view, the binocular 1 has a specific rectangular field of view 6, as shown in FIG. 3. Meanwhile, the digital image storage unit 2 also has a rectangular field of view 7 slightly larger than the rectangular field of view 6.

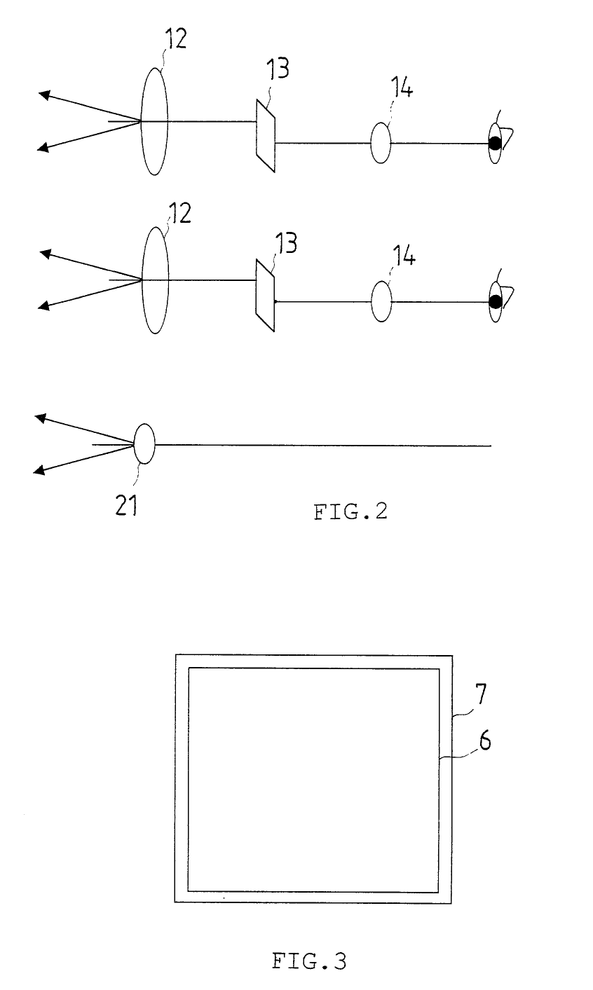

Please refer to FIG. 2. The binocular 1 and the digital image storage unit 2 have parallel optical axes. Therefore, the digital image storage unit 2 can take an image identical to that observed through the binocular 1.

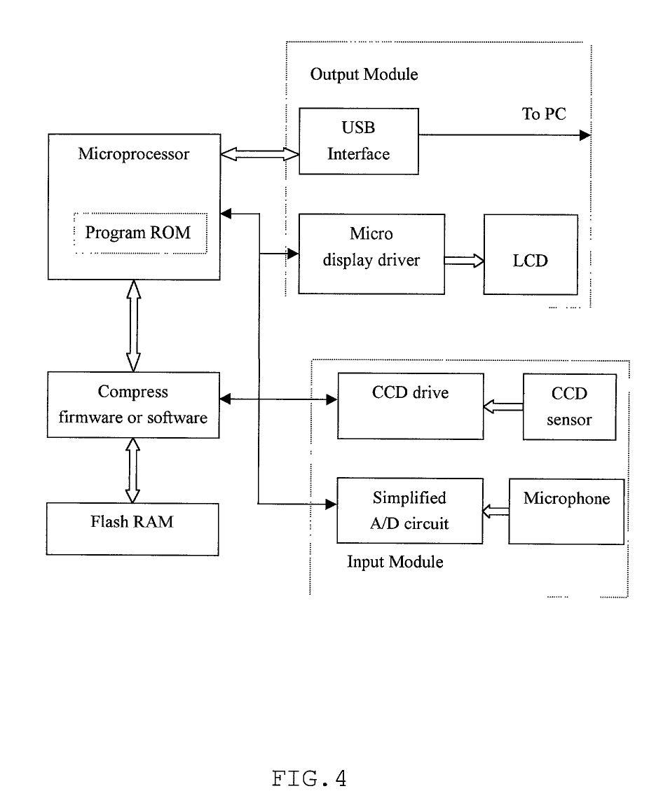

FIG. 4 is a block diagram of the circuitry of the digital image storage unit 2. The digital image storage unit 2 takes an image via a CCD sensor. The image taken is then sent from the CCD sensor to a microprocessor via a CCD driver, and is compressed before being stored in a memory. Any audio signal is received at a microphone and then converted into a digital signal at an analog/digital conversion circuit. The converted digital signal is then sent to the microprocessor and compressed for storing in the memory. The stored images may be displayed on a mini liquid crystal display (LCD) through a driver. The stored images and audio signals may also be output by way of connecting to a personal computer (PC) via, for example, a universal serial bus (USB).

Based on the intended use of the present invention as mentioned above, when it is supposed that the present invention is used to observe things at a distance of about 100 meters from a user, and factors, such as any possible moving of the user or observer, a manner of handling the binocular 1, a ratio of the size of an observed things to a visual field, and a preferable field of view of about 10 meters, are taken into consideration, the binocular 1 should have a view angle set to 6 degrees (that is, 2×tan⁻¹ (5/100) ˜6 degrees). Normally, the digital image storage unit 2 has a view angle that is about 15% larger than that of the binocular 1 and is therefore set to about 7 degrees, so that the whole image that is observed via the binocular 1 could be taken by the digital image storage unit 2, as shown in FIG. 3.

The digital image storage unit 2 includes the following five major parts in its configuration:
a. Photographing module: the lens 21 focuses light beams to form an image on the photoelectric sensor CCD;
b. Signal processing: it enables CCD or CMOs (complementary metal-oxide semiconductor) photo-signals conversions;
c. Image/audio signal compression: signals are compressed to occupy reduced storage volume of the memory;
d. Image/audio signal storage: this part consists of a semiconductor memory, such as a flash random-access memory (RAM) or a static random-access memory (SRAM); and
e. Image display: this part includes a mini LCD panel.

The optical design involved in the binocular 1 is a critical technical aspect to meet the goal of supplying the present invention at a low price. In the present invention, plastic lenses replace the expensive glass lenses to obtain the same good optical performance and enable low manufacturing cost.

The binocular 1 includes an optical system having two parallel optical axes. The following are specifications for the binocular 1 of the present invention:
a. Magnifying power: 7×;
b. Rectangular field of view: having a length-to-breadth ratio of 4:3;
c. View angle: 6 degrees;
d. Objective lens clear aperture: 20 mm; and
e. Resolution ratio: 8 seconds (with a diffraction limit of 7 seconds).

As having been mentioned above, the binocular 1 includes two objective lenses 12, a Porro prism 13, and two eyepieces 14. Detailed specifications for these components are described as below:
1. The objective lenses 12:
   a. Focal length: 140 mm;
   b. F-number: 7;
   c. View angle: 6 degrees;
   d. Configuration: two pieces of achromatic doublet plastic lenses; and
   e. Material of lenses: PMMA (polymethyl methacrylate) and PC (polycarbonate).
2. The prism 13:
   a. Clear aperture: 15 mm; and
   b. Material: PMMA.
3. The eyepieces 14:
   a. Focal length: 20 mm;
   b. View angle: 42 degrees;
   c. Eye relief: 10 mm; and
   d. Exit pupil aperture: 3 mm.

The binocular 1 of the present invention has smaller objective lens clear aperture of 20 mm and smaller view angle of 6 degrees, as compared to a conventional regular binocular that usually has an objective lens and clear aperture within the range from 30 to 50 mm and a view angle of 8 degrees. Therefore, the binocular 1 of the present invention having the above-described specifications is suitable for use in an environment having higher brightness, such as in a ball game, an automobile racing or a musical performance held in daytime. Generally, an advantage of the binocular is its big view angle. However, a view angle of 6 degrees is sufficient when the binocular 1 is used with the digital image storage unit 2. Due to the reduced clear aperture and the reduced view angle, it is possible to replace the glass lenses with the considerably low-cost plastic lenses and thereby achieve one of the very important objects of the present invention, that is, to provide the present invention at low cost.

The digital image storage unit 2 of the present invention has the following specifications:
1. Photographing module:
   a. CCD:
      a-1) Color;
      a-2) ¼″; and
      a-3) 300,000 pixels.
   b. Optical lens:
      b-1) Focal length: 32 mm;
      b-2) F-number: 6;
      b-3) View angle: 7 degrees; and
      b-4) Material: 3-element plastic lens.
2. Signal processing: Capable of CCD or CMOs photo-signal conversions.
3. Image/audio signal compression: Signals are compressed to occupy reduced storage volume of the memory.
4. Image/audio signal storage: This part consists of a semiconductor memory, such as a flash RAM or a SRAM.
5. Image display: Amini LCD panel 24 of 3.84 mm×2.88 mm is disposed on one of the two optical axes of the binocular 1.

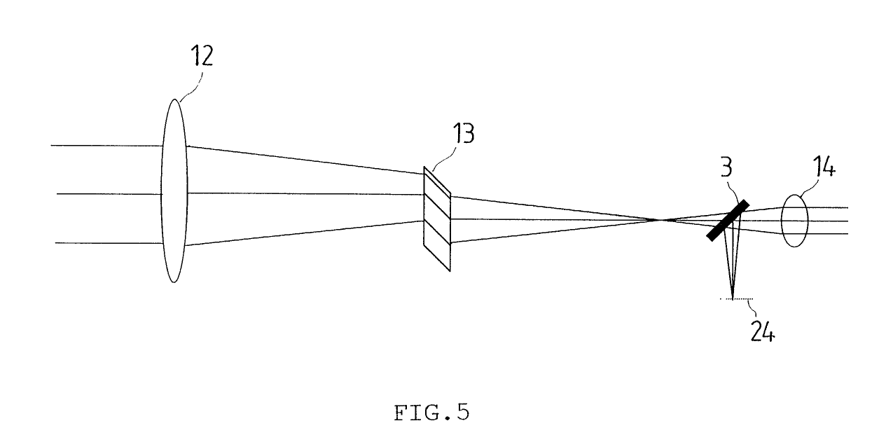

To enable the image taken with the digital image storage unit 2 to be shown within the field of view of the binocular 1, a semitransparent reflection mirror 3 is disposed in front of a focus of one eyepiece 14 at a 45-degree angle relative to the optical axis, and the mini LCD panel 24 is positioned at a point immediately below the focus, as shown in FIG. 5. A display status of the mini LCD 24 could be controlled through a push button on the digital image storage unit 2. For example, when the shutter key 22 is half depressed, a power supply for displaying is cut off and a user may observe distant views at the eyepieces 14 and sees what is seen with an ordinary binocular. And, when the user depresses and holds a display power key while using a hand to shield a front side of the objective lenses 12, only a magnified image on the mini LCD is seen. That is, the user would see the exact image being taken by the digital image storage unit 2. Meanwhile, the user may observe the actual image via another body tube 11 of the binocular 1, so as to compare the actually viewed image to the image taken by the digital image storage unit 2 and checks whether a desired image is being taken.

From the above description based on an embodiment of the present invention, it is known that, by associating of the digital image storage unit 2 with the binocular 1, the user is able to observe a distant scene via the binocular 1 and see via the field of view 7 an image being taken by the digital image storage unit 2, so as to accurately take desired images.

1. A binocular having digital image storage function, comprising:
a binocular including two body tubes, each of which being separately provided at two ends with an objective lens and an eyepiece, and a prism being disposed between said objective lens and said eyepiece; and
a digital image storage unit being located between said two body tubes and including at least an image sensor for taking an image, a shutter key for controlling said taking of image by said image sensor, a driver and a microprocessor for compressing an image taken by said image sensor and storing said compressed image in a memory; and
said binocular and said digital image storage unit having parallel optical axes, so that an image taken by said digital image storage unit is the same as a picture being seen by a user via said binocular, enabling the user to take desired images with said digital image storage unit.

2. The binocular having digital image storage function as claimed in claim 1, wherein said digital image storage unit further includes an audio signal processing system, in which a microphone receives an audio signal that is converted into a digital signal at an analog/digital conversion circuit and then sent to said microprocessor, so that said converted audio signal is compressed and stored in said memory.

3. The binocular having digital image storage function as claimed in claim 1, wherein said image taken by said digital image storage unit is output to a personal computer via a universal serial bus.

4. The binocular having digital image storage function as claimed in claim 2, wherein said image and said audio signal taken and received by said digital image storage unit are output to a personal computer via a universal serial bus.

5. The binocular having digital image storage function as claimed in claim 1, wherein said binocular further comprises a semitransparent reflection mirror disposed in front of a focus of one said eyepiece at a 45-degree angle relative to an optical axis of said eyepiece, and said digital image storage unit including a mini liquid crystal display (LCD) panel disposed at a point immediately below said focus corresponding to said reflection mirror, so that said image taken by said digital image storage unit is displayed on said mini LCD through a driver; and wherein said digital image storage unit further comprises a push button for controlling a display status of said mini LCD; whereby when a user views at said eyepieces while a display power is cut off, what being seen by the user is the same as an image that could be seen with an ordinary binocular, and when the user views at said eyepieces while a display power key is held in a depressed position and a front side of said objective lenses is shielded with one hand, what being seen by the user is a magnified image on said mini LCD, that is, an image exactly taken by said digital image storage unit.

6. The binocular having digital image storage function as claimed in claim 2, wherein said binocular further comprises a semitransparent reflection mirror disposed in front of a focus of one said eyepiece at a 45-degree angle relative to an optical axis of said eyepiece, and said digital image storage unit including a mini liquid crystal display (LCD) panel disposed at a point immediately below said focus corresponding to said reflection mirror, so that said image taken by said digital image storage unit is displayed on said mini LCD through a driver; and wherein said digital image storage unit further comprises a push button for controlling a display status of said mini LCD; whereby when a user views at said eyepieces while a display power is cut off, what being seen by the user is the same as an image that could be seen with an ordinary binocular, and when the user views at said eyepieces while a display power key is held in a depressed position and a front side of said objective lenses is shielded with one hand, what being seen by the user is a magnified image on said mini LCD, that is, an image exactly taken by said digital image storage unit.

7. The binocular having digital image storage function as claimed in claim 1, wherein said binocular has optical specifications suitable for observing a mid-range scene about 50 to 200 meters away, and all or some of said objective lenses and said eyepieces being made of plastic lenses; and said optical specifications for said binocular including:
Magnifying power: within the range from 5× to 8×;
Clear aperture: within the range from 15 to 25 mm;
Length-to-breadth ratio of field of view: 4:3; and
Diagonal view angle: within the range from 5 to 7 degrees.

8. The binocular having digital image storage function as claimed in claim 1, wherein said binocular has a rectangular field of view, and said rectangular field of view having a length-to-breadth ratio of 4:3 which is the same as that of said image sensor in said digital image storage unit.

9. A binocular telescope comprising:
a first body tube having a first eyepiece and a first objective lens, said first eyepiece located at a proximate end of said first body tube and said first objective lens being located at a distal end of said first body tube;
a second body tube having a second eyepiece and a second objective lens, said second eyepiece being located at a proximate end of said second body tube and said second objective lens being located at a distal end of said second body tube, said second body tube being oriented substantially parallel to said first body tube, said first and second body tubes oriented along a first optical axis to provide a first field of view, said first and second objective lenses each having a focal length for focusing on objects at mid range; and,
a digital image storage unit having an image sensor for capturing an image, said image sensor located along a second optical axis, said digital image storage unit located between said first and second body tubes, said second optical axis being separate from said first optical axis, said digital image storage unit providing a second field of view which is substantially similar to said first field of view.

10. The binocular telescope of claim 9, wherein said digital image storage unit further includes a memory for storing said image.

11. The binocular telescope of claim 10, wherein said memory is flash memory.

12. The binocular telescope of claim 9, wherein said digital image storage unit further comprises:
a microphone to receive an analog audio signal;
an analog-to-digital conversion circuit, coupled to said microphone, to convert said analog audio signal to a digital audio signal; and,
a memory, coupled to an output of said analog-to-digital conversion circuit, for storing said digital audio signal.

13. The binocular telescope of claim 12, wherein said digital audio signal is provided to a personal computer.

14. The binocular telescope of claim 9, further comprising a port to be connected to a personal computer, where said image is provided to a personal computer from said digital image storage unit through said port.

15. The binocular telescope of claim 14, wherein said port is a universal serial bus port.

16. The binocular telescope of claim 9, further comprising a display panel coupled to said digital image storage unit, said display panel to display said image from said image sensor of said digital image storage unit.

17. The binocular telescope of claim 16, wherein said display panel is a liquid crystal display (LCD) panel.

18. The binocular telescope of claim 16, further comprising a semitransparent reflective element, where said image displayed on said display panel is viewable through at least one of said first and second eyepieces by orienting said reflective element along said first optical axis, orienting said display panel substantially perpendicular to said first optical axis, and directing said image as displayed on said display panel in the direction of said at least one of said first and second eyepieces using said reflective element.

19. The binocular telescope of claim 18, further comprising a first viewing mode and a second viewing mode, said image to be displayed on said display panel during said first viewing mode, and said image to not be displayed on said display panel during said second viewing mode.

20. The binocular telescope of claim 19, wherein during said first viewing mode, at least one of said first and second objective lenses is shielded and the image displayed on said display panel is the only image viewable through a corresponding one of said first or second eyepieces.

21. A method of viewing an image, having a first field of view, comprising:
viewing the image using (i) a first body tube having a first eyepiece and a first objective lens, said first eyepiece located at a proximate end of said first body tube and said first objective lens being located at a distal end of said first body tube, and (ii) a second body tube having a second eyepiece and a second objective lens, said second eyepiece being located at a proximate end of said second body tube and said second objective lens being located at a distal end of said second body tube, said second body tube being oriented substantially parallel to said first body tube, said first and second body tubes being oriented along a first optical axis, said first and second objective lenses each having a focal length for focusing on objects at mid range; and
capturing the image, said image having a second field of view substantially the same as said first field of view, through an image sensor located in a digital image storage unit, said image sensor located along a second optical axis, said digital image storage unit being located between said first and second body tubes, said second optical axis being separate from said first optical axis.

22. The method of claim 21, further comprising storing said image in a digital format in a memory of said digital image storage unit.

23. The method of claim 22, wherein said memory is flash memory.

24. The method of claim 21, further comprising:
receiving an analog audio signal;
converting said analog audio signal to a digital audio signal; and,
storing said digital audio signal in a memory of said digital image storage unit.

25. The method of claim 24, further comprising providing said digital audio signal to a personal computer.

26. The method of claim 21, further comprising providing said image to a personal computer.

27. The method of claim 26, wherein said image is provided to said personal computer through a universal serial bus connection.

28. The method of claim 21, further comprising providing said image from said image sensor of said digital image storage unit to a display panel, and displaying said image on said display panel.

29. The method of claim 28, wherein said display panel is a liquid crystal display (LCD) panel.

30. The method of claim 28, further comprising viewing said image displayed on said display panel through at least one of said first and second eyepieces by orienting a semitransparent reflective element along said first optical axis, orienting said display panel substantially perpendicular to said first optical axis, and directing said image as displayed on said display panel in the direction of said at least one of said first and second eyepieces using said reflective element.

31. The method of claim 30, further comprising switching from a first viewing mode to a second viewing mode, where said image is displayed on said display panel during said first viewing mode, and said image is not displayed on said display panel during said second viewing mode.

32. The method of claim 31, wherein during said first viewing mode, at least one of said first and second objective lenses is shielded and the image displayed on said display panel is the only image viewable a corresponding one of said first or second eyepieces.

33. The method of claim 21, wherein in said field of view is substantially a rectangular field of view.

34. The method of claim 33, further comprising providing said image to a personal computer, said image to be displayable by said personal computer in said rectangular field of view.

35. A binocular telescope comprising:
a first body tube having a first eyepiece and a first objective lens, said first eyepiece located at a proximate end of said first body tube and said first objective lens being located at a distal end of said first body tube;
a second body tube having a second eyepiece and a second objective lens, said second eyepiece being located at a proximate end of said second body tube and said second objective lens being located at a distal end of said second body tube, said second body tube being oriented substantially parallel to said first body tube, said first and second body tubes oriented along a first optical axis to provide a first field of view;
a digital image storage unit having an image sensor for capturing an image, said image sensor located along a second optical axis, said digital image storage unit being located between said first and second body tubes, said second optical axis being separate from said first optical axis, said digital image storage unit providing a second field of view which is substantially similar to said first field of view;
a display panel coupled to said digital image storage unit, said display panel to display said image from said image sensor of said digital image storage unit; and
a semitransparent reflective element oriented along said first optical axis, where said image displayed on said display panel is viewable through at least one of said first and second eyepieces by orienting said display panel substantially perpendicular to said first optical axis, and directing said image as displayed by said display panel towards said at least one of said first and second eyepieces using said reflective element.

36. The binocular telescope of claim 35, wherein said digital image storage unit further includes a memory for storing said image.

37. The binocular telescope of claim 35, further comprising a port to be connected to a personal computer, where said image is provided to a personal computer from said digital image storage unit through said port.

38. The binocular telescope of claim 35, further comprising a first viewing mode and a second viewing mode, where said image is displayed on said display panel during said first viewing mode, and said image is not displayed on said display panel during said second viewing mode.

39. The binocular telescope of claim 38, wherein during said first viewing mode, one of said first or second objective lenses is shielded and the image displayed on said display panel is the only image viewable through a corresponding one of said first or second eyepieces.

40. A method of viewing an image, having a field of view, comprising:
viewing the image using (i) a first body tube having a first eyepiece and a first objective lens, said first eyepiece located at a proximate end of said first body tube and said first objective lens being located at a distal end of said first body tube, and (ii) a second body tube having a second eyepiece and a second objective lens, said second eyepiece being located at a proximate end of said second body tube and said second objective lens being located at a distal end of said second body tube, said second body tube being oriented substantially parallel to said first body tube, said first and second body tubes being oriented along a first optical axis;
capturing the image, said image having a second field of view substantially the same as said first field of view, through an image sensor located in a digital image storage unit, said digital image storage unit being located between said first and second body tubes, said second optical axis being separate from said first optical axis;
displaying said image from said image sensor on a display panel; and
orienting a semitransparent reflective element along said first optical axis, orienting said display panel substantially perpendicular to said first optical axis, and
directing said image displayed on said display panel towards at least one of said first and second eyepieces using said reflective element.

41. The method of claim 40, further comprising storing said image in a digital format in a memory of said digital image storage unit.

42. The method of claim 40, further comprising providing said image to a personal computer.

43. The method of claim 40, further comprising switching from a first viewing mode to a second viewing mode, where said image is displayed on said display panel during said first viewing mode, and said image to not be displayed on said display panel during said second viewing mode.

44. The method of claim 43, wherein during said first viewing mode at least one of said first and second objective lenses is shielded and the image displayed on said display panel is the only image viewable through a corresponding one of said first or second eyepieces.
